(19) United States
(12) Patent Application Publication
(10) Pub. No.: US 2005/0008924 A1
(43) Pub. Date: Jan. 13, 2005

(54) Compact multi-functional modules for a direct methanol fuel cell system

(76) Inventor: Sanjiv Malhotra, Castro Valley, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/861,946

(22) Filed: Jun. 4, 2004

Related U.S. Application Data
(60) Provisional application No. 60/480,148, filed on Jun. 20, 2003.

(51) Int. Cl. H01M 8/02; H01M 8/10; H01M 8/04

(52) U.S. Cl. 429/38; 429/32; 429/26

(57) ABSTRACT

A compact direct methanol fuel cell (DMFC) system based on modules is provided. The system addresses issues related to the critical functions of water recovery from the cathode exhaust, carbon dioxide separation from the anode output stream, dilution of incoming concentrated methanol and thermal management in a DMFC system. The system is based on a more natural solution and avoids bulky and power-consuming devices; hence increasing DMFC system's efficiency by at least 25%, reducing DMFC system's cost and increasing DMFC system's reliability compared to traditional condensor-based DMFC systems. In addition, the system is relatively small in size compared to these condensor-based DMFC systems mainly due to the use of modules based on plates that are nicely integrated as a DMFC system. The individual size of the system is typically reduced by about 35% or more compared to traditional condensor-based DMFC systems.

### CROSS-REFERENCE TO RELATED APPLICATIONS

This application is cross-referenced to and claims priority from U.S. Provisional Application 60/480,148 filed Jun. 20, 2003, which is hereby incorporated by reference.

### FIELD OF THE INVENTION

The present invention relates generally to direct methanol fuel cells. More particularly, the present invention relates to a direct methanol fuel cell system using compact multi-functional modules for water management, thermal regulation, carbon dioxide separation and methanol dilution.

### BACKGROUND

A direct methanol fuel cell (DMFC), like an ordinary battery, provides dc electricity from two electrochemical reactions. These reactions occur at electrodes to which reactants are continuously fed. The negative electrode (anode) is maintained by supplying a fuel such as methanol, whereas the positive electrode (cathode) is maintained by the supply of oxygen or air. When providing current, methanol is electrochemically oxidized at the anode electro-catalyst to produce electrons, which travel through the external circuit to the cathode electro-catalyst where they are consumed together with oxygen in a reduction reaction. The circuit is maintained within the cell by the conduction of protons in the electrolyte.

A DMFC system integrates a DMFC stack with different subsystems for instance for the management of water, fuel, air, humidification and thermal condition of the system. These subsystems are aimed to improve the overall efficiency of the system, which typically suffers from kinetic constraints within both electrode reactions together with the components of the cell stack.

One issue with traditional DMFC systems relates to the separation of carbon dioxide from the anode exhaust stream. Carbon dioxide is typically separated prior to re-circulating the liquid mixture (methanol and water) back to the fuel cell stack inlet and is implemented by means of a gas/liquid separator system. In this traditional approach, the methanol and water vapor are first condensed by means of a cooling fan (or radiator) and the carbon dioxide gas thus separated from the liquid (methanol and water) is vented out. The recovered liquid methanol and water are then pumped by means of a re-circulating pump to a mixing tank where they are mixed with fresh methanol prior to being fed to the fuel cell stack. The fresh methanol is diluted with the recovered methanol and water to achieve a desired concentration prior to feeding it to the stack. The traditional process of separation of carbon dioxide from the methanol and water mixture is power consuming, requires bulky equipment and quite inefficient since some of the methanol and water present in a vapor form in the anode exhaust stream are lost along with the carbon dioxide.

Another example of an issue with traditional DMFC systems relates to water management, which is particularly critical for a polymer electrolyte membrane (PEM) stack used for a DMFC system. On the one hand, the DMFC stack must maintain sufficient water content to avoid membrane dehydration and to avoid dry out of the cathode catalyst layer. Membrane dehydration increases the membrane resistance while a dry cathode lowers the oxygen reduction activity of the platinum catalyst; both reduce DMFC stack performance. On the other hand and more common in practice, water management problems in a DMFC stack are more often associated with excess water in the stack rather than dry out. Excess water can interfere with the diffusion of oxygen into the catalyst layer by forming a water film around the catalyst particles (flooding). In traditional DMFC systems the fuel cell stack water content is managed by controlling the stack temperature and air flow rate by for instance an air compressor system and an air-to-air condensor. However, such systems consume large amounts of power relative to the power produced by the DMFC stack reducing the overall efficiency.

Yet another example of an issue with traditional DMFC systems relates to the thermal management. Typically, the thermal management is controlled by both the anode and the cathode stream. The cathode side cooling is achieved by cooling of the stack by means of the water vaporization by the air flowing through the stack. The cathode side cooling takes advantage of the high stoichiometric ratios (SR ranging from 4 to 6) and air flow rates flowing through the cathode for evaporating the water present in the cathode. The water evaporation in turn results in cooling of the stack. The exiting air saturated with water is then passed through a condenser system for the cathode side to condense the water and recycling it for replenishing the water in the anode feed. The anode side cooling is achieved by means of cooling the methanol and water mixture after it exits from the stack. This cooling radiator placed at the anode exit stream cools and condenses the liquid (methanol and water) and thus separates it from the carbon dioxide. This traditional approach for thermal management requires voluminous equipment that consumes a significant amount of power produced at the fuel cell stack for their operation and tends to reduce the overall system efficiency and system power density.

Still another example of an issue with traditional DMFC systems is to have a commercial fuel cell system that is water autonomous, which requires neat or commercially available methanol to be the only fuel fed to the DMFC. However, the neat methanol fuel needs to be strongly diluted in-situ in a bulky methanol-water mixing tank to reduce the methanol crossover across the membrane electrolyte due to concentration gradients. These problems are traditionally being addressed by either trying to develop a membrane that would restrict methanol and water permeation or by employing bulky and power consuming equipment (condensers, mixing tank, cooling fans for the condenser and heat and mass exchangers) for recycling water back to the anode from the cathode outlet stream. Due to the lack of a suitable membrane that could restrict water and methanol crossover the latter option is the preferred option. However, this approach leads to low power density as well as huge parasitic power consumption from multiple components and sub-systems constituting the balance of plant or auxiliary systems in a DMFC.

Accordingly, there is a need to develop new subsystems that could be integrated in a DMFC system to reduce size and improve efficiency.

### SUMMARY OF THE INVENTION

The present invention is a novel and elegant solution of a compact direct methanol fuel cell (DMFC) system. The present system addresses issues related to the critical functions of water recovery from the cathode exhaust, carbon dioxide separation from the anode output stream, dilution of incoming concentrated methanol and thermal management in a DMFC system. The system provided by this invention is based on a more natural solution and avoids bulky and power-consuming devices; hence improving DMFC system's efficiency by at least 25% compared to traditional condensor-based DMFC systems. In addition, the system is relatively small in size compared to these condensor-based DMFC systems mainly due to the use of modules based on plates that are nicely integrated as a DMFC system. The individual size of the system is typically reduced by about 35% or more compared to traditional condensor-based DMFC systems.

Furthermore, the DFMC system of this invention reduces cost by eliminating a majority of components and subsystems of a condensor-based DFMC system. Due to the elimination of these components and subsystems the present system also has an increased reliability; i.e. moving parts prone to wear and tear are eliminated. These traditional parts are replaced by more robust and solid-state components such as membranes and plates.

The DMFC system includes a DMFC stack and a plurality of plates. Each plate has a flow field. Each plate of set of plates form different modules, each with a specific functionality, which together are nicely integrated with the DMFC stack. These modules are a carbon dioxide separation module, a water management module, a mixing module, and a methanol module. The modules could be arranged in any type way, which is primarily determined by the type of application and space constraints.

More particularly, a first set of plates separates carbon dioxide from the anode outlet stream of DMFC stack, which is the carbon dioxide module. Two of these plates enclose a membrane permeable to carbon dioxide. A second set of plates extracts water (which could then be used for methanol dilution) from the cathode outlet stream of DMFC stack, which is the water management module. Here plates enclose a membrane permeable to air and/or to water vapor. A third plate or third set of plates mixes (i) the output from the first set of plates substantially devoid of carbon dioxide, (ii) the output from the second set of plates which substantially includes extracted water and (iii) methanol from a methanol source. The third plate of third set of plates is the mixing module that outputs the mixture as the anode input fuel to the anode inlet of DMFC stack.

The compact integration of the plates, flow fields, or plates and flow fields as modules and as DMFC system is accomplished by using special holes such as access holes, exit holes and through holes. In particular, the system includes one or more through holes through one or more of the plurality of plates to directly connect two or more flow fields. In addition, the system includes one or more through holes through one or more of the plurality of plates to directly connect an input or an output stream of the DMFC stack with one of the flow fields.

The system includes several variations. For instance, one variation is to have a fourth set of plates that forms an air-to-air heat exchanger. Another variation is to utilize the third plate or third set of plates is as a thermal regulator. In addition, radiation fan(s) or thermo-insulator layer(s) could be added for thermal regulation.

### BRIEF DESCRIPTION OF THE FIGURES

The present invention together with its objectives and advantages will be understood by reading the following summary in conjunction with the drawings, in which:

FIG. 1 shows an exemplary embodiment of a direct methanol fuel cell (DMFC) system according to the present invention;

FIG. 2 shows example 1 of a DMFC system according to the present invention;

FIG. 3 shows a design architecture of a compact multi-functional module (CMM) according to example 1 in FIG. 2;

FIG. 4 shows example 2 of DMFC system according to the present invention;

FIG. 5 shows a design architecture of a compact multi-functional module (CMM) according to example 2 in FIG. 4;

FIG. 6 shows example 3 of DMFC system according to the present invention; and

FIG. 7 shows a design architecture of a compact multi-functional module (CMM) according to example 3 in FIG. 6.

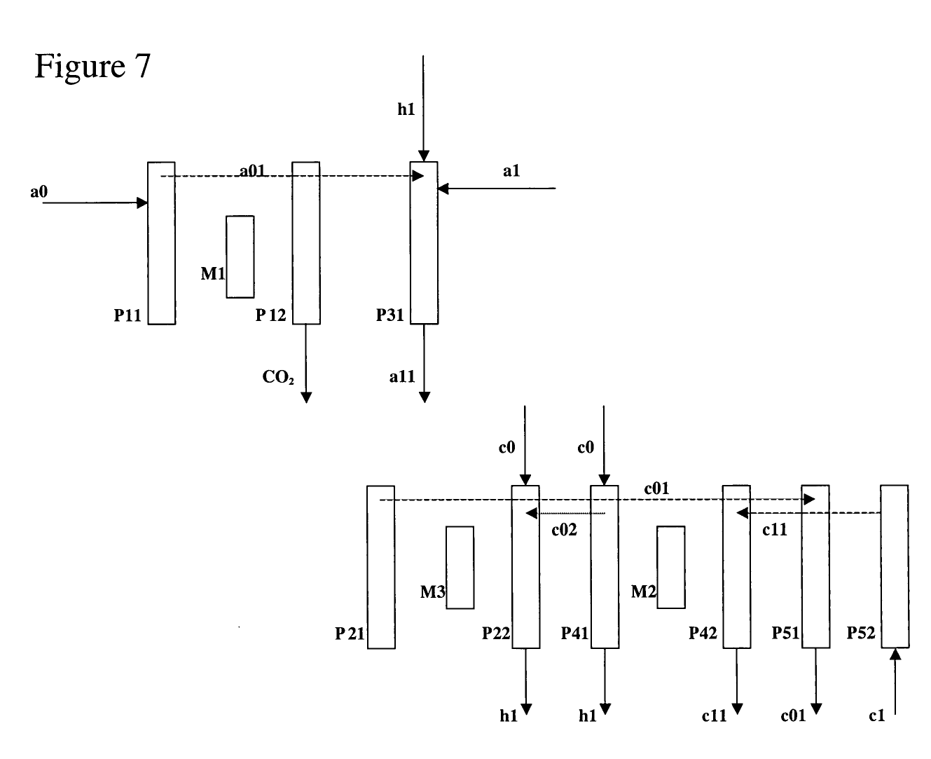

### DETAILED DESCRIPTION OF THE INVENTION

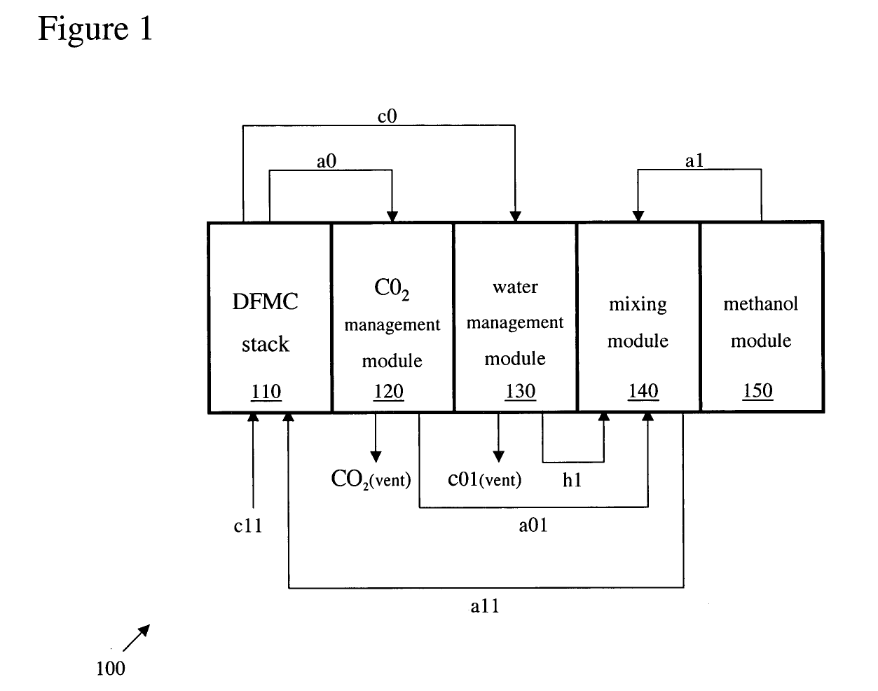

FIG. 1 shows an overview of a direct methanol fuel cell (DMFC) system 100 with a plurality of compact subsystems each with a specific functionality. These subsystems could also be referred to as modules. The key idea of the integration of the multi-functional modules is to reduce the overall DMFC system's size as well as to improve overall DMFC system's efficiency. Example of applications of the DFMC system of the present invention are: (i) as an on-board augmentation and battery charger for electric forklifts, (ii) as an auxiliary power unit for class-8 trucks, (iii) as an off-grid power source for applications such as weather stations, data monitoring systems for oil and gas applications, telecom sites, traffic systems or the like, (iv) as a power or energy source as well as a source for back-up to a grid for mission critical applications such as telecom sites, hospitals or the like.

DMFC system 100 includes a DMFC stack 110, carbon dioxide separation module 120, a water management module 130, a mixing module 140, and a methanol module 150. The modules are preferably stacked and integrated together using plates to provide a small and compact DMFC system package. The plates have flow fields for input or output streams that are for instance edged or machined to the face of the plates. The plates could be constructed from a variety of materials such as metal, stainless steel, graphite or any other thermally conductive material with sufficient tensile strength. Methods to construct such plates and flow fields are known in the art.

Integration of the different modules as a compact stacked system, requires the plates, flow fields, or plates and flow fields to have holes for entry of a stream (access holes), for passage of stream from one plate to the another plate while bypassing plates positioned in between (through holes), and for exiting of a stream (exit holes). In the embodiment of FIG. 1 access holes are used for anode input stream a0 to the carbon dioxide module and a cathode input stream c0 to the water management module. The mixing module also has three access holes, which are for the output streams a01, h1 and a1 originating from the exit holes of the carbon dioxide module, water management module and the methanol source, respectively. The DMFC stack has two access holes for the cathode input air stream c11 and an anode input stream a11 that is connected to an exit hole of the mixing module. The exit holes described supra connect a stream from one plate to another plate, even bypassing some plates in between via through-holes. However, there are also exit holes that do not connect streams between plates but are used for venting away from the plates or system, e.g. to the open air. Examples of such exit holes are for venting carbon dioxide CO₂ (vent) as output from the carbon dioxide module and venting particularly unused air c01 (vent) as output from the water management module.

FIG. 1 shows a particular arrangement of the different modules, however the present invention is not limited to this arrangement and could be changed to different configurations. The choice of the arrangement could be determined by a preference of the specific holes and connections, or space constraints of related to an application. It would be possible to arrange the modules in a more or less cubic or square arrangement instead of a rectangular arrangement. The size of each module depends on the number of plates used.

The size of a compact carbon dioxide module could be about 9″×6″×½″ (about 27 cubic inches). In this example each plate could then have a thickness of about ¼″. In general, the individual measurement could vary, but the volume of the carbon dioxide module would still typically be lower than about 30 cubic inches, and more preferably equal or lower than about 27 cubic inches. A person of average skill in the art would readily appreciate that currently available techniques make it possible to manufacture much smaller modules than 27 cubic inches, all of which are part of the scope of the invention.

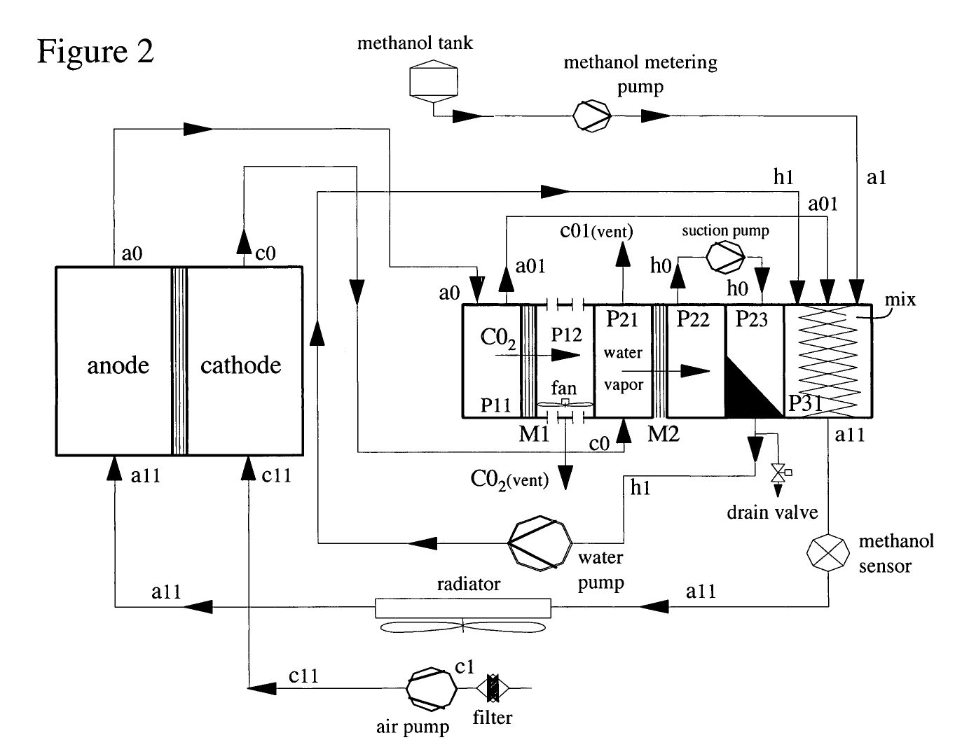

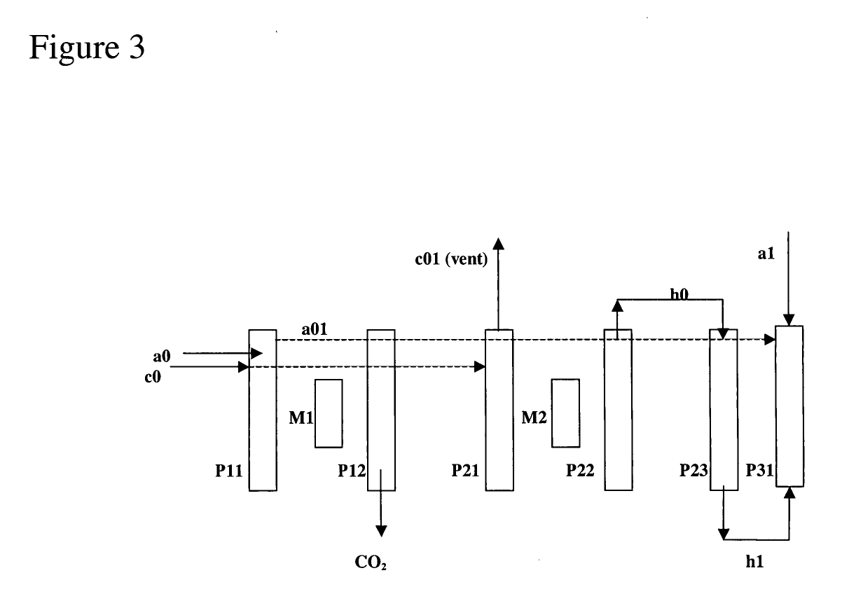

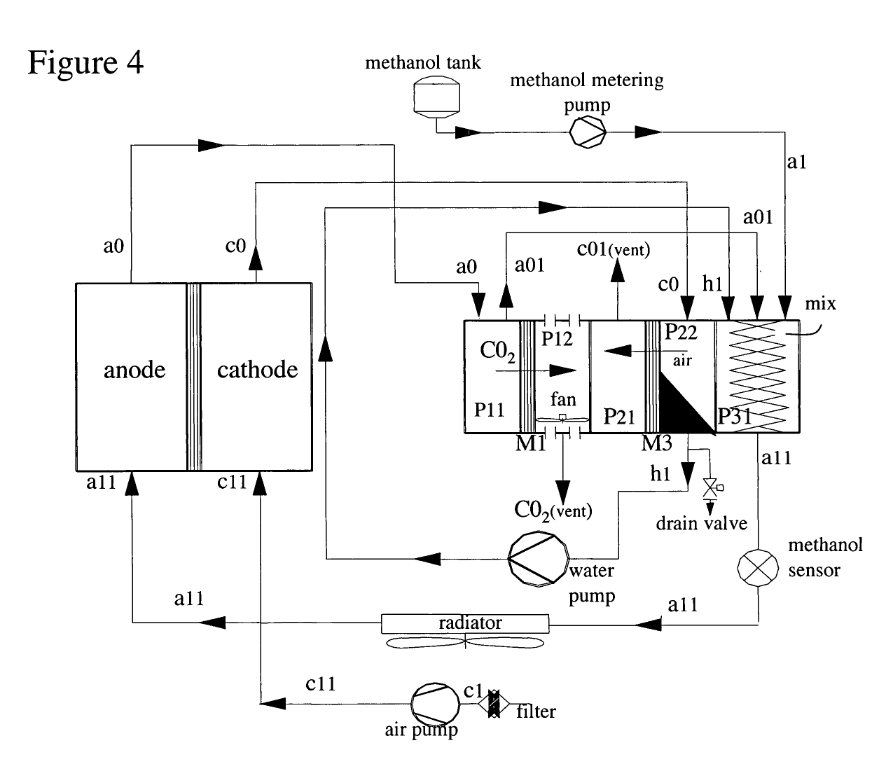

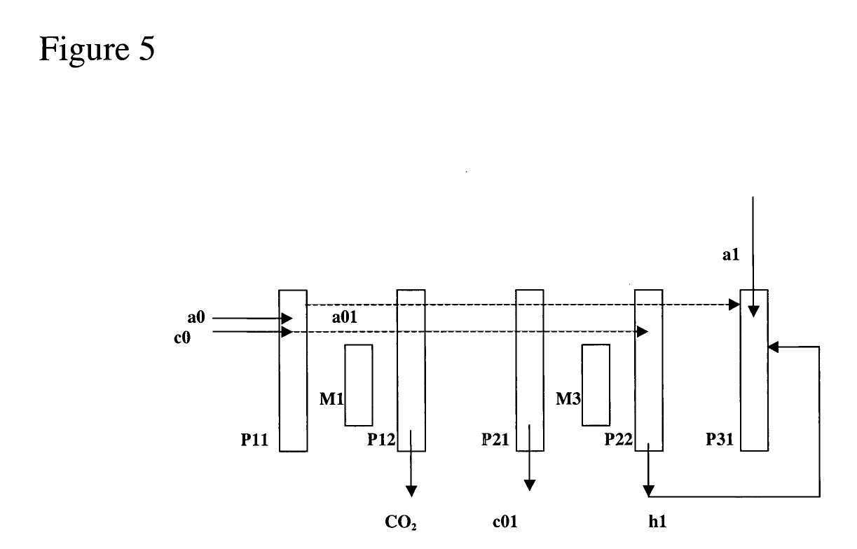

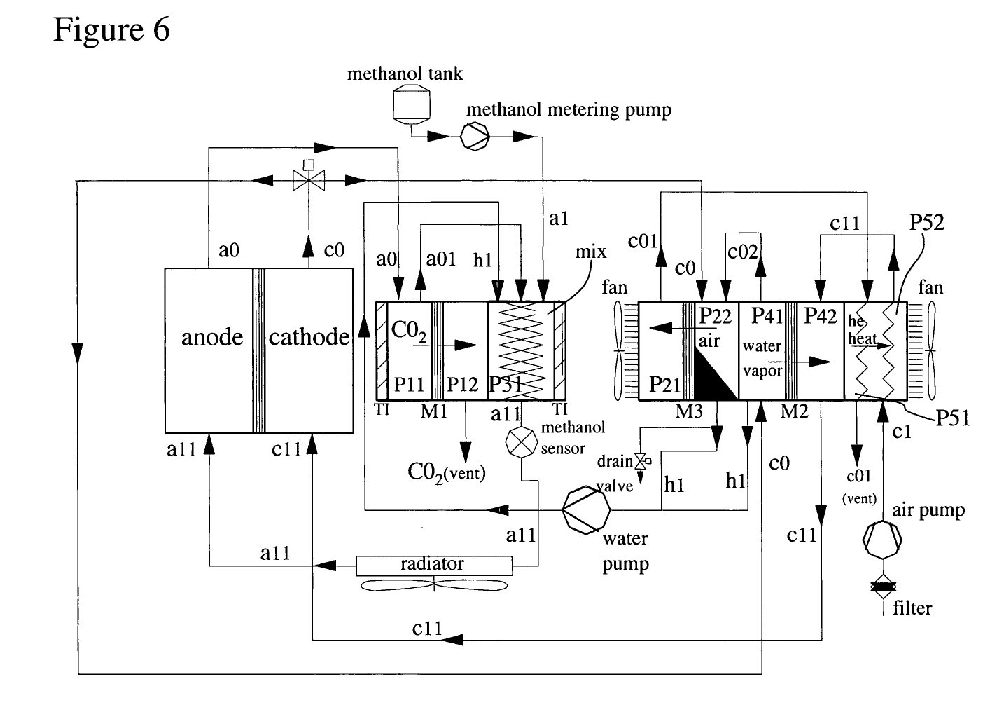

The size of such a compact water management module could be about 9″×6″×½″ (about 27 cubic inches) (See FIGS. 4-5). In this example each plate could then have a thickness of about ¼″, i.e. two plates. In another example, with three plates of ¼″ thick the compact water management module could be about 9″×6″×¾″ (about 40 cubic inches) (See FIGS. 2-3). In still another example, with four plates of ¼″ thick, the compact water management module could be about 9″×6″×1″ (about 54 cubic inches) (See FIGS. 5-6). In general, the individual measurement could vary, but the volume of the water management module would still typically be lower than about 27, 40 or 54 cubic inches (or significantly lower). A person of average skill in the art would readily appreciate that currently available techniques make it possible to manufacture much smaller modules than 27, 40 or 54 cubic inches respectively, all of which are part of the scope of the invention.

The size of a compact mixing module could be about 9″×6″×¼″ (about 13.5 cubic inches). In this example the plate could then have a thickness of about ¼″. In general, the individual measurement could vary, but the volume of the mixing module would still typically be lower than about 14 cubic inches, and more preferably equal or lower than about 14 cubic inches. A person of average skill in the art would readily appreciate that currently available techniques make it possible to manufacture much smaller modules than 14 cubic inches, all of which are part of the scope of the invention.

The size of a compact methanol module (source) could be about one Gallon to about 20 Gallon, and typically depends on the type of application as a person of average skill in the art would readily appreciate.

The overall size reduction of the present DMFC system compared to traditional condensor-based DMFC systems is at least 35%, and even more if the plates are further reduced in size. The overall DMFC system's efficiency of the present system compared to traditional condensor-based DMFC systems is at least increased by 25%. The improvements in size reduction and efficiency are predominantly the result of the elegant solutions for each of the modules and their integration; i.e. elimination of power consuming devices and introduction of passive devices such as devices with membranes. As a person of average skill in the art would readily appreciate, the power density is inversely related to the volume of the system, i.e. increase in volume of the system would result in a decrease in the overall system power density. The size of a 1 kW DMFC system is about 85-115 lts.

The following description includes different exemplary embodiments of how the different modules could be designed to provide functionality and how they could be integrated in a DMFC system.

### EXAMPLE 1

FIGS. 2-3 show an example of an approach for implementing the critical functions of water recovery from the cathode exhaust, carbon dioxide separation from the anode output stream, dilution of incoming concentrated methanol and thermal management in a DMFC system. The individual modules are described without a particular preference in order.

1.1 Carbon Dioxide Separation Module

FIGS. 2-3 show a carbon dioxide separation module with a set of plates, typically two plates P11 and P12, sandwiched together. Plates P11 and P12 enclose a membrane M1 that is permeable to carbon dioxide. Each plate, P11 and P12, has a flow field that is edged or machined to the plates. Each flow field faces and is in contact with the membrane M1. In other words, membrane M1 is a barrier between the two flow fields.

The flow field of plate P11 receives an anode output stream a0 of direct methanol fuel cell stack 120. This anode output a0 stream typically contains carbon dioxide, unused methanol and unused water. The carbon dioxide present in stream a0 is produced as a result of the electrochemical oxidation reaction occurring at the anode. The temperature of the stream a0 is around the temperature of the direct methanol fuel cell stack (+/−2 degrees Celsius) and therefore stream a0 is responsible for carrying a significant amount of heat generated at the stack.

The key idea of membrane M1 is that is it permeable to carbon dioxide, substantially restrictive to other gases than carbon dioxide and substantially restrictive to liquids present in the anode output stream a0. The driving force for carbon dioxide permeation through the membrane M1 is the difference in the partial pressures of carbon dioxide across the membrane M1, i.e. the carbon dioxide partial pressure in plate P11 is higher than in plate P12. In one embodiment, the membrane may require a pressure differential of around 0.1 to 0.5 psig, however, the present invention is not limited to this pressure range and could be in any range as long as the carbon dioxide passage and extraction occurs.

Examples of suitable membranes include hybrid membranes of polymer and ceramics as well as hydrophobic microporous membranes. The idea behind using a hybrid membrane is to have a membrane that would not only have a higher permeability for carbon dioxide but also have a high selectivity towards carbon dioxide, which is shown by quite a few hybrid membranes prepared by a combination of sol-gel reaction and polymerization. Examples of suitable membranes are for instance, but not limited to, diphenyldimethoxysilane (DPMOS), trimethoxysilane (TMOS), phenyltrimethoxysilane (PTMOS), poly(amide-6-b-ethyleneoxide) and silica, aminopropyltrimethoxysilane (APrTMOS), silica-polyimide on alumina, or the like. A typical flux of carbon dioxide of the membrane is in the range of 10⁻⁶ to 10⁻⁷ mol/m²-sec-Pa. A person of average skill in the art would appreciate that other kinds of membranes could have a different flux range, which would all be within the scope of this invention.

The anode output stream membrane M1 flows through flow field, whereby the carbon dioxide permeates through membrane M1. At the other end of this flow field the original anode output stream is left with unused methanol and unused water, i.e. substantially without carbon dioxide. The unused methanol and unused water exits from the flow field as output a01. Output a01 could be used in a mixing module where it could be mixed with methanol fuel from methanol module 150 and water from water management module 130. This mixture from mixing module 140 could then be used as an anode input stream all to direct methanol fuel cell stack 110. At the other the flow field of plate P12 of the carbon dioxide device the permeated carbon dioxide is collected and vents from the flow field through an exit hole as CO₂ (vent) to the open air.

1.2 Water Management Module

FIGS. 2-3 show a water management module with plates P21, P22 and P23 and membrane M2 to separate and recover water from air in the cathode exhaust stream c0 utilizing membrane M2. The cathode output stream c0 of DMFC stack enters and flows through a flow field of plate P21 (e.g. grooves etched or machined on the inside face of plate P21) where c0 is in contact with an air dehydration membrane M2. Membrane M2 performs two functions:
(i) M2 is a selective air dehydration membrane permitting only water vapor to pass through it and restricting the flow of air or liquid water in c0 to pass through it. In one embodiment, a small low power suction pump could be used to create a vacuum or a low pressure differential across the membrane M2 to facilitate the selective transport of water vapor; and
(ii) M2 acts as a barrier between plates P21 and P22.

Examples of air dehydration membranes suitable as M2 are for instance, but not limited to, Cactus™ (PRISM™) membrane available from Air Products and Chemicals or an air dehydration membrane available from Balston Inc. or Parker Hannifin. These membranes typically have a flux for water vapor as defined by the following equation developed by Air Products Inc.:
N_{wv}=Pᵢ/L=(300 to 1500) 10⁻⁶ cm³/cm².s.cmHg
where N_{wv} is the flux of water vapor through the membrane, Pᵢ is the permeability of water vapor through the membrane, and L is the thickness of the membrane.

At plate P21, air in stream c0 is vented out. The idea behind extracting water vapor from c0 is to provide an adequate supply of liquid water for dilution of the pure methanol from the methanol reservoir on the fuel (anode) side. Furthermore, the idea is to provide water for the electrochemical methanol oxidation reaction occurring at the anode side (i.e. water is a reactant for that reaction. The water vapor in c0 that passed through membrane M2 to plate P22 exits as h0 and then to plate P23. The water vapor in stream h0 condenses to liquid water due to the phenomena of over-saturation in plate P23; the separation of air from the water vapor leads to an increase in the vapor pressure of water vapor thus leading to condensation of water vapor in plate P23. The liquid water thus produced is then pumped by means of a water pump from P23 as stream h1, i.e. the water condensate stream.

1.3 Air Supply

An air supply subsystem is added to provide the oxygen c11 to the cathode(s) to satisfy the electrochemical demand in a DMFC stack. The stack has an oxygen requirement in addition to the oxygen consumed by the electrochemical current producing reaction. Methanol being a small, completely water miscible molecule has a tendency to migrate from the anode side (fuel side) over to the cathode side (air side) of the cells. This crossover methanol burns on the cathode catalyst producing an additional oxygen demand, additional waste heat, and additional water in the stack. The function of the air supply subsystem is multifold, i.e. (i) to provide oxygen to the cathode(s), (ii) control the water level in the stack by removing the water produced by the fuel cell reaction and crossover, and (iii) remove waste heat from the stack.

Air c11 at ambient conditions is fed by means of an air pump to the cathode of the direct methanol fuel cell stack. The air could have first passed through an air filter before feeding into the air pump. C11 provides oxygen for the electrochemical reduction reaction occurring at the cathode as well as for the reaction with any methanol crossing over to the cathode across the membrane. The unused air saturated with water vapor and some liquid water exits the DMFC stack as cathode output stream c0, typically at temperatures around the operating temperature of the stack. The temperature of the DMFC stack can range anywhere from 40 degrees Celsius to 80 degrees Celsius. The water vapor and liquid water present at the cathode side of the DMFC stack are a result of both the water producing oxygen reduction reaction occurring at the cathode as well as due to the water crossover from the anode side to the cathode across the membrane electrolyte.

1.4 Mixing Module

Plate P31 is an example of a mixing module, which has a reservoir accessible by three inputs. The first input is stream a01 from the carbon dioxide separation module, which enters plate P31. The second input is stream h1 from plate P23 that is fed into plate P31 by means of a water pump as described supra. Additionally, the third input is a stream of fresh methanol or neat methanol namely a1 fed from a methanol module by means of a metering pump into plate P31. Plate P31 is a passive mixing device or a compartment where h1, a01 and a1 are mixed with the purpose of diluting the incoming neat methanol stream a1 prior to its being fed into the anode side of the stack as all. Plate P31 is also used for another function, i.e. thermal management since stream a01 is the primary carrier of heat generated at the anode. A majority of this heat is used to thermally condition or raise the temperature of methanol stream a1, since this is typically at room temperature. This process ensures that the temperature of the stream a11 exiting from plate P31 is close to that of the temperature of the direct methanol fuel cell stack. If necessary, one could add a small radiator fan for cooling stream a11.

1.5 Compact Multi-Functional Module

FIG. 3 shows an example of constructing a compact multi-functional module system for a DMFC system. This design includes various plates, membranes and holes, such as:
1. Plate P11 with an access hole for a0.
2. Plate P11 and plate P12 with a through hole to allow the passage of c0.
3. Plate P11 with an exit hole for a1.
4. Plates P12, P21, P22 and P23 with a through hole to allow the passage of a01.
5. Plate P12 with an exit for carbon dioxide (CO₂).
6. Plate P21 with an access hole for c0.
7. Plate P21 with an exit hole for c01.
8. Plate P22 with an exit hole for h0.
9. Plate P23 with an access hole for h0.
10. Plate P23 with an exit hole for h1.
11. Plate P31 with an access hole for a01, h1 and a1.
12. Plate P31 with an exit hole for all.
13. Plate P11 with a flow field (e.g. grooved inside face) for flow of a0 and a01.
14. Plates P12 with a flow field (e.g. grooved inside face) for flow of carbon dioxide (CO₂).
15. Plate P21 with a flow field (e.g. grooved inside face) for flow of c0 and c0.
16. Plate P22 with a flow field (e.g. grooved inside face) for flow of h0.

### EXAMPLE 2

FIGS. 4-5 show another example of an approach for implementing the critical functions of water recovery from the cathode exhaust, carbon dioxide separation from the anode output stream, dilution of incoming concentrated methanol and thermal management in a DMFC system. This example is a variation of example 1 with the difference in the recovery of water related to the water management device/module. For a description of the other components or modules the reader is referred to the description supra.

2.1 Water Management

In this embodiment, cathode output stream c0 enters the flow field of plate P22 (e.g. through grooves etched or machined on the inside face of plate P22) where c0 is in contact with membrane M3. Membrane M3 performs two functions namely:
(i) Membrane M3 is a selective permeable membrane that permits only air to pass through it and restricts the transport of any water vapor or liquid water through it (this in contrast to membrane M2 described with respect to FIGS. 4-5). A pressure differential across membrane M3 is responsible for the air passage. In one example the pressure differential across membrane M3 is about 0.5 to 0.75 psi, however, the present invention is not limited to this pressure range and could be in any range as long as the air passage and extraction occurs.
(ii) Membrane M3 acts as a barrier between plate P21 and plate P22. Air passes through membrane M3 to plate P21 and is vented out from plate P21 as c01. The water vapor in stream c0 condenses to liquid water due to the phenomena of over-saturation. The permeation of air across the membrane M3 leads to an increase in the vapor pressure of water vapor in the mixture in P22. This increase in the vapor pressure of water vapor is the driving force for over-saturation and the resultant condensation of water vapor to liquid water. The liquid water thus produced from the separation of air from stream c0 is then pumped by means of a water pump from plate P22 to plate P31 as stream h1, i.e. the water condensate stream. The function of plates P21 and P22 and membrane M3 is essentially to separate and recover water from air in the cathode output stream c0 by utilizing membrane M3. In light of this invention this module is referred to a water management module (see also FIG. 1).
   2.1 Compact Multi-Functional Module

FIG. 5 shows an example of constructing a compact multi-functional module system for a DMFC system. This design includes various plates, membranes and holes, such as:
1. Plate P11 with an access hole for a0.
2. Plates P11, P12 and P21 with a through hole to allow the passage of c0.
3. Plate P11 with an exit hole for a01.
4. Plates P12, P21 and P22 with a through hole to allow the passage of a01.
5. Plate P12 with an exit hole for carbon dioxide (CO₂).
6. Plate P21 with an exit hole for c01.
7. Plate P22 with an access hole for c0.
8. Plate P22 with an exit hole for h1.
9. Plate P31 with an access hole for a01, h1 and a1.
10. Plate P31 with an exit hole for all.
11. Plate P11 with a flow field (e.g. grooved inside face) for flow of a0 and a01.
12. Plates P12 with a flow field (e.g. grooved inside face) for flow of carbon dioxide (CO₂).
13. Plate P21 with a flow field (e.g. grooved inside face) for flow of c01.
14. Plate P22 with a flow field (e.g. grooved inside face) for flow of c0 and h1.

### EXAMPLE 3

FIGS. 5-6 show yet another example of an approach for implementing the critical functions of water recovery from the cathode exhaust, carbon dioxide separation from the anode output stream, dilution of incoming concentrated methanol and thermal management in a DMFC system. This example incorporates aspects of examples 1 and 2. In addition, other variations are added that are described infra. For a description of the other components or modules the reader is referred to the description supra.

3.1 Variations

A first variation relates to the carbon dioxide separation module, which could be stacked with plate P31 that serves as a (passive) mixing device in a similar fashion as in example 1 and 2. In addition, at either side of this compact multi-functional module of plates P11, P12 and P31 thermal insulators TIs could be added to prevent heat loss through radiation from stream a01.

A second variation relates to the water management module employing both solutions from example 1 and 2. FIGS. 5-6 show the cathode output stream c0 from DMFC stack (i.e. unused air saturated with water vapor and liquid water at temperatures close to that of the stack) split up into two streams c0 using a flow control valve. A first stream of c0 is fed into plate P41. The combination of plates P41 and plate P42 and membrane M2 is similar to the water management module in example 1. The difference is that plate P23 is omitted in example 3 and the output stream c11 of plate P42 now directly feeds to the cathode input of the direct methanol fuel cell stack. A second stream of c0 is fed into plate P22. The combination of plates P21 and plate P22 and membrane M3 is similar to the water management module in example 2. An additional note is that the air in stream c0 permeates through membrane M3 to plate P21 where and exits as stream c01.

A third variation also relates to the water management module, whereby plate P22 could be cooled to condense the vapor and thus separate the air from the recovered water. Condensation would be a result of cooling provided by forced air-cooling fans as well as a result of over-saturation. Over-saturation would occur since the water vapor pressure in P22 would increase due to the separation of air due to the introduction of c02. The cooling would be particularly beneficial in case a micro-porous hydrophobic type of membrane M3 is used.

A fourth variation relates to humidification and thermal conditioning. Stream c1 is fresh air introduced into the system by means of an air pump into plate P52. Additionally an air filter could be used before entering the air pump. Stream c1 is passed through an air-to-air heat exchanger (plates P51 and P52) where it is thermally conditioned by stream c01 that originates from plate P21. After the thermal conditioning process stream c01 is vented into the atmosphere as c01 (vent). The thermally conditioned stream of air exits as c11 and is passed through plate P42 where it is in contact with membrane M2. Membrane M2 humidifies stream c11 using the water from c0. The thermally conditioned and humidified air stream exits from plate P42 as stream c11 and is introduced into the cathode for the electrochemical reduction reaction. Meanwhile, the dehumidified stream c0 in P41 exits as c02 and is introduced into plate P22. In addition, radiator fans could be used, e.g. at the side of plates P51 and P21 to provide thermal regulation.

3.2 Compact Multi-Functional Module

FIG. 6 shows an example of constructing a compact multi-functional module system for a DMFC system. This design includes various plates, membranes and holes, such as:
1. Plate P11 with an access hole for a0.
2. Plate P11 with an exit hole for a01.
3. Plate P12 with a through hole to allow the passage of a01.
4. Plate P12 with a grooved inside face for flow of carbon dioxide (CO₂).
5. Plate P31 with an access hole for a01, h1 and a1.
6. Plate P31 with an exit hole for all.
7. Plate P22 with an access hole for c0.
8. Plate P21 with an access hole for c01.
9. Plates P22 and P41 with an access hole for c0.
10. Plates P22 and P41 with an exit hole for h1.
11. Plate P41 with an exit hole for c02.
12. Plate P22 with an access hole for c02.
13. Plates P22, P41, and P42 with a through hole to allow the passage of c01.
14. Plate P51 with an access hole for c01.
15. Plates P42 and P52 with an exit hole for c11.
16. Plate P51 with an exit hole for c01.
17. Plate P52 with an access hole for c1.
18. Plate P51 with a through hole for c11.
19. Plate P42 with an access hole for c11.
15. Plate P11 with a grooved inside face for flow of a0 and a01.
16. Plates P12 with a flow field (e.g. grooved inside face) for flow of carbon dioxide (CO₂).
20. Plate P21 with a flow field (e.g. grooved inside face) for flow of c01.
21. Plate P22 with a flow field (e.g. grooved inside face) for flow of c0, h1 and c02.
22. Plate P41 with a flow field (e.g. grooved inside face) for flow of c0, c02 and h1.
23. Plate P42 with a flow field (e.g. grooved inside face) for flow of c11.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. In one variation, the plates with flow fields for the passage of the fluids could also be designed with fins for an efficient heat transfer mechanism. In another variation, prior to entering the anode of the DMFC stack, stream all could be passed through a small radiator for cooling. In yet another variation, the invention could be included a DMFC system generating 1 kW or more since it would clearly overcome the size and efficiency problems with traditional condensor-based systems in this power range. However, the invention is not limited to such a power range and could also be a DMFC system of 50 W to 1 kW or, in general, any type of power range or application. All such variations are considered to be within the scope and spirit of the present invention as defined by the following claims and their legal equivalents.

1. A direct methanol fuel cell system, comprising:
(a) a direct methanol fuel cell stack; and
(b) a plurality of plates each having a flow field, forming a stack of plates and stacked with said direct methanol fuel cell stack,
wherein a first set of plates separates carbon dioxide from the anode outlet stream of said direct methanol fuel cell stack,
wherein a second set of plates extracts water from the cathode outlet stream of said direct methanol fuel cell stack, and
wherein a third plate or third set of plates mixes (i) the output from said first set of plates substantially devoid of said carbon dioxide, (ii) the output from said second set of plates substantially comprising said extracted water and (iii) methanol from a methanol source, wherein said mixture flows as anode input fuel to the anode inlet of said direct methanol fuel cell stack.

2. The system as set forth in claim 1, wherein a pair of said first set of plates encloses a membrane permeable to said carbon dioxide.

3. The system as set forth in claim 1, wherein a pair of said second set of plates encloses a membrane permeable to air or to water vapor.

4. The system as set forth in claim 1, further comprising one or more through holes through one or more of said plurality of plates to directly connect two or more flow fields.

5. The system as set forth in claim 1, further comprising one or more through holes through one or more of said plurality of plates to directly connect an input or an output stream of said direct methanol fuel cell stack with one of said flow fields.

6. The system as set forth in claim 1, wherein a fourth set of said plates forms an air-to-air heat exchanger.

7. The system as set forth in claim 1, wherein said third plate or third set of plates is as a thermal regulator.

8. The system as set forth in claim 1, further comprising one or more radiation fans for thermal regulation.

9. The system as set forth in claim 1, further comprising one or more thermo-insulator layers.

10. A direct methanol fuel cell system, comprising:
(a) a direct methanol fuel cell stack with an anode flow plate and a cathode flow plate;
(b) a plurality of plates each having a flow field, forming a stack of plates and stacked with said direct methanol fuel cell stack;
(c) a first hole or first set of holes through one or more of said plurality of plates to directly connect the output of said anode flow field plate with one of said flow fields; and
(d) a second hole or second set of holes through one or more of said plurality of plates to directly connect the output of said cathode flow field plate with one of said flow fields.

11. The system as set forth in claim 8, further comprising a third hole or third set of holes through one or more of said plurality of plates to directly connect the input of said anode flow field plate with one of said flow fields.

12. The system as set forth in claim 8, further comprising a third hole or third set of holes through one or more of said plurality of plates to directly connect the input of said cathode flow field plate with one of said flow fields.

13. The system as set forth in claim 8, wherein one or more flow fields have exit holes to vent gases.
